(19) United States
(12) Patent Application Publication
(10) Pub. No.: US 2024/0286710 A1
(43) Pub. Date: Aug. 29, 2024

(54) ALL-TERRAIN VEHICLE TO SNOWMOBILE CONVERSION KIT ASSEMBLY

(71) Applicant: Richard Zock, Lapeer, MI (US)

(72) Inventor: Richard Zock, Lapeer, MI (US)

(21) Appl. No.: 18/174,749

(22) Filed: Feb. 27, 2023

(51) Int. Cl. B62M 27/02

(52) U.S. Cl. CPC B62M 27/02; B62M 2027/025; B62M 2027/027

(57) ABSTRACT

An all-terrain to snowmobile conversion kit provides two rear track assemblies and two front skis to hub adapter. A bell-shaped adapter block is provided for operatively associating the front skis to the front hubs. The conversion kit also provides a wheel hub adapter for mounting the track assemblies to the rear axle hub by way of a splined half shaft or an alternative configuration.

### BACKGROUND OF THE INVENTION

The present invention relates to kits for converting all-terrain vehicles and more particularly, an assembly kit for converting an all-terrain vehicle to a snowmobile.

Converting an all-terrain vehicle (also known as a light utility vehicle, a quad bike, or simply a quad) to be able to run in snow and sand as effectively as a snowmobile would be a boon to the all-terrain vehicle industry.

Currently kits for converting an all-terrain vehicle (ATV) to a snowmobile, however, only sell the rear tracks or the front hub to ski adapter, but not a complete assembly. Present kits are also not designed to be compatible with each other, and the resulting mismatch of rear-portion and front portion component from different kits can result in suboptimal performance and cause damage to the ATV.

A need exists for a complete assembly kit for converting an all-terrain vehicle to a snowmobile, thereby delivering an all-in-one solution that avoids ‘Frankenstein’ mismatching of two or more assembly kits.

### SUMMARY OF THE INVENTION

The present invention is an assembly kit for converting the drive system of an all-terrain vehicle from wheels and tires to a ski and ski track system.

The present invention embodies a complete kit whereby both the track system and front skis are compatible and work together to perform the necessary tasks that are required by the quad in snow, sand, and muddy conditions.

In one aspect of the present invention, a kit for converting an all-terrain vehicle (ATV) to a snowmobile includes the following: two front axle adapters for operatively associating two skis with a front axle of the ATV, one ski on each opposing end, respectively, of said front axle; and two rear axle adapters for operatively associating two track assemblies, one ski on each opposing end, respectively, of a rear axle of the ATV.

In another aspect of the present invention, the kit for converting the ATV to a snowmobile further includes wherein each front axle adapter includes: a head plate portion; a body portion; and a neck portion interconnecting the head plate portion and the body portion, wherein the neck portion tapers inward so as to define a bell shape relative the body portion, wherein a thickness of the head plate portion is one-third or less than a thickness of the body portion, and wherein the head plate portion abuts a hub of the front axle.

In yet another aspect of the present invention, the kit for converting the ATV to a snowmobile further includes wherein each rear axle adapter includes either (a) a half shaft have a spline portion for engaging one of the two track assemblies; and a threaded insert lock nut that secures wherein the half shaft to said one of the two track assemblies; or (b) wherein each rear axle adapter includes an axle mount having a four-corner arrangement of connectors; an adapter portion comprising a first cross portion and a second cross portion, each cross portion having a four-corner arrangement of connection points offset from each other by approximately forty-five degrees; a core body interconnecting the axle mount and the adapter portion; a core hole extending a length of the adapter portion; and a recessed second cross opening communicating with the core hole.

These and other features, aspects and advantages of the present invention will become better understood with reference to the following drawings, description, and claims.

### BRIEF DESCRIPTION OF THE DRAWINGS

FIG. 1 is a top perspective view of an exemplary embodiment of the present invention, shown after assembly.

FIG. 2 is a tabular view of a parts list 18 of an exemplary embodiment of the present invention.

FIG. 3 is a partial front perspective view of an exemplary embodiment of the present invention.

FIG. 4 is a detailed exploded perspective view of an exemplary embodiment of the present invention.

FIG. 5 is a top perspective view of an exemplary embodiment of a wheel hub adapter of the present invention.

FIG. 6 is a front perspective view of an exemplary embodiment of a block and plate of the present invention.

FIG. 7 is a side perspective view of an exemplary embodiment of a threaded insert lock nut of the present invention.

FIG. 8 is a front perspective view of an exemplary embodiment of the present invention.

FIG. 9 is an exploded perspective view of an exemplary embodiment of the present invention.

FIG. 10 is a rear perspective view of an exemplary embodiment of the present invention.

FIG. 11 is a section view of an exemplary embodiment of the present invention, taken along line 11-11 in FIG. 10.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an all-terrain to snowmobile conversion kit. The conversion kit provides a bell-shaped adapter block for operatively associating the front skis to the front axle. The conversion kit also provides two wheel hub adapters to choose from for mounting the track assemblies to the rear axle hub by way of a splined half shaft or an alternative configuration.

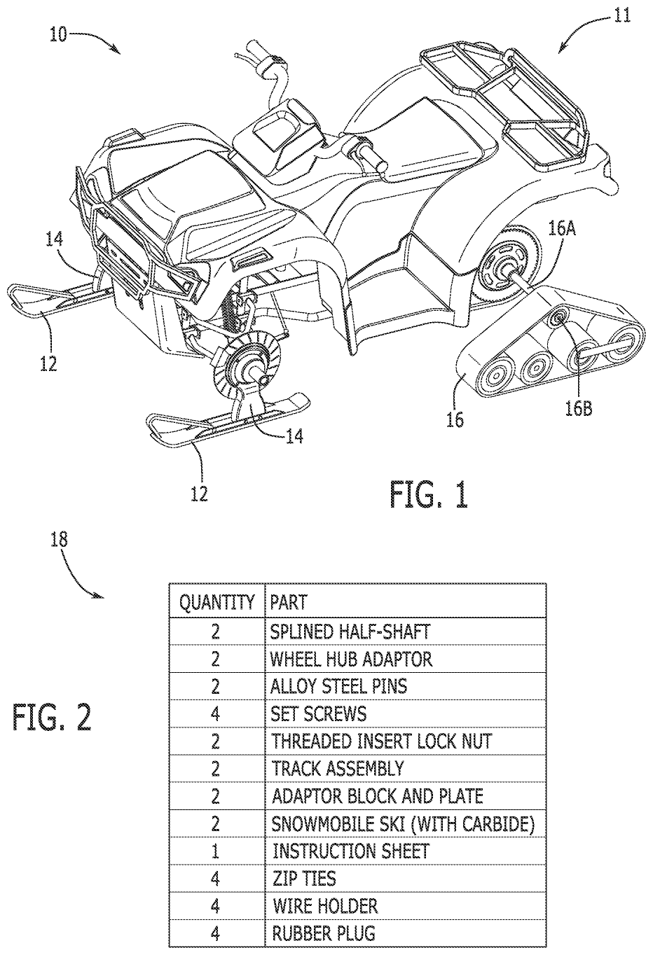

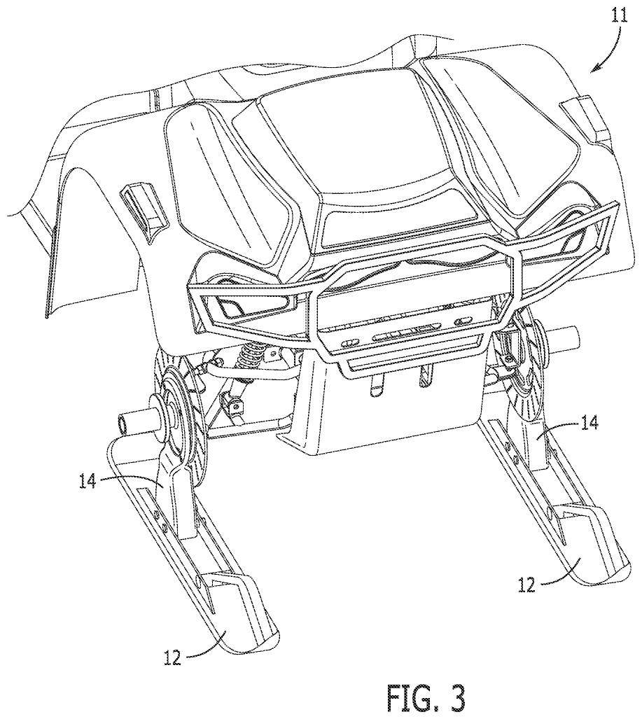

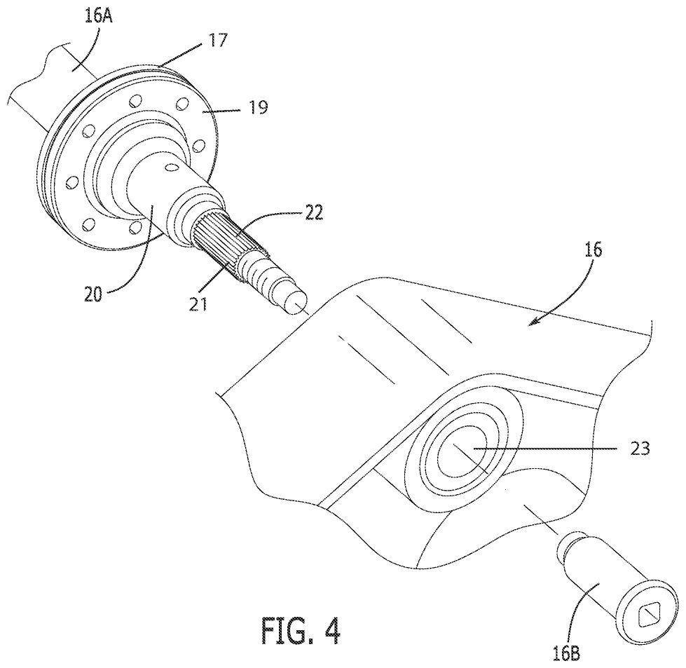

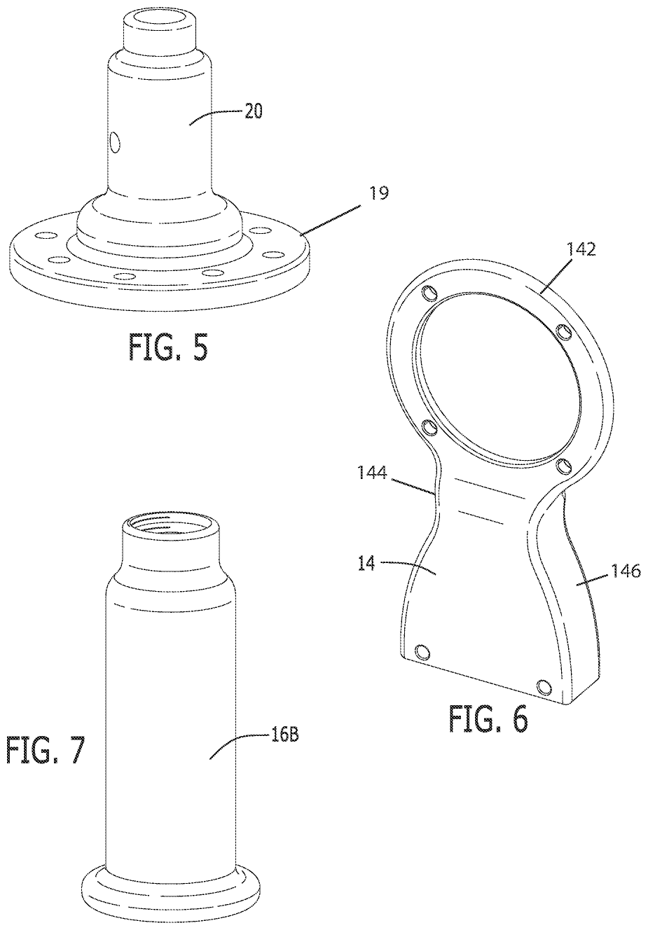

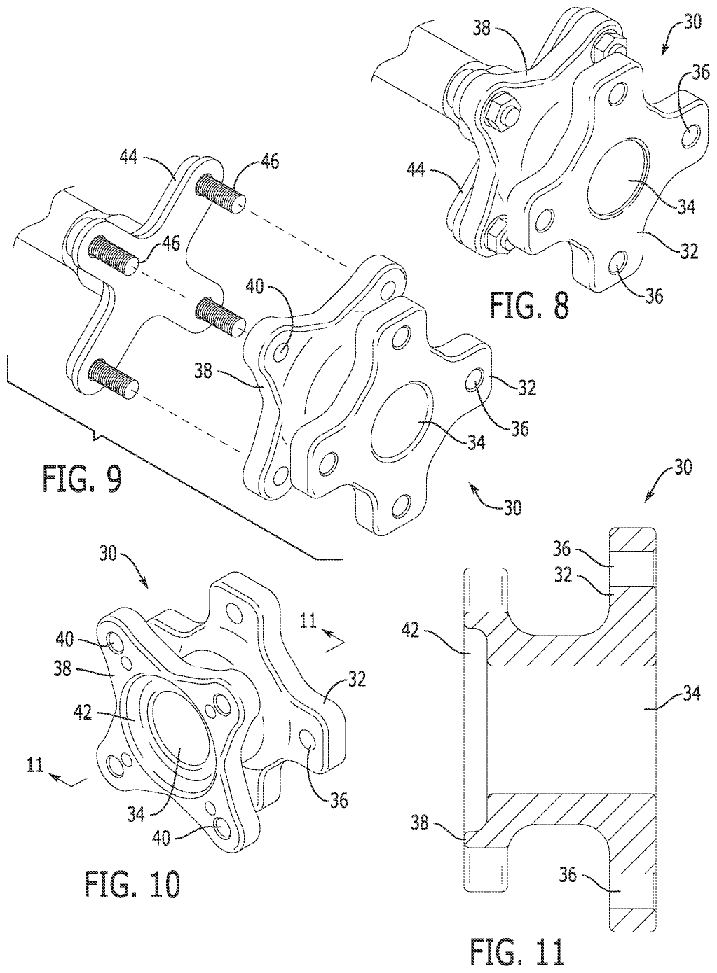

Referring to FIGS. 1-11, the present invention may include an assembly kit 10 for converting an all-terrain vehicle (ATV) 11 to a snowmobile. The assembly kit 10 may provide at least the parts shown in FIG. 2 table of the parts list 18.

For the front of the ATV/snowmobile 11, skis 12 provide turning capabilities for the ATV/snowmobile 11. A bell-shaped adapter ski block 14 operatively associates each front ski 12 and its respective existing front hub. The adapter ski block 14 provides an arcuate head plate portion 142 and a body portion 146 interconnected by a neck portion 144 that tapers inward. The neck and body portions 144 and 146 provide the bell shape, wherein the thickness of the plate portion 142 is at least one-third than of the body portion 146. The dimensionality and shape of adapter ski block 14 provides superior strength when traveling over rough terrain.

At the rear, each track assembly 16 may be operatively associated with the rear axle 16A by way of one of either two wheel hub adapters 20 or 30.

The first wheel hub adapter 20 may include a splined half-shaft 22 that mounts to the hub 17 of the axle 16A by way of an interface plate 19 opposite the distal end of the splined half-shaft 22. The track assembly 16 provides an aperture 23 through which the splined half-shaft 22 slides to be secured in a locked engagement by way of a threaded insert lock nut 16B. The aperture 23 may have grooves for slidably receive the spline portion 21 of the splined half-shaft 22.

The second wheel hub adapter 30 operatively associates to an axle by way of an axle mount 44 having axle bolts 46, typically spaced apart in a four-corner arrangement. The second wheel hub adapter 30 has first and second cross portions 32 and 38, each having a four-corner arrangement of bolt holes 36 and 40, respectively, for engaging the above-mentioned axle bolts 46. Notably, the two different four-corner arrangements of bolt holes 40 and 36 are offset from each other by approximately forty-five degrees. The first and second cross portions 32 and 38 are interconnected by a tube defining a core hole 34 extending the length of the second wheel hub adapter 30. The core hole 34 may communicate with a recessed second cross opening 42.

The first and second wheel hub adapters 20 and 30 allow for the easy installation (adaptation) of the track assembly 16 onto the existing rear axle 16A.

A rubber plug or wire clamp and zip tie may be attached through the holes through the front brake rotor allowing the ski's minimum pivot movement while the ATV/snowmobile 11 is in movement.

A method of using the present invention may include the following. The conversion kit assembly 10 disclosed herein may be provided. When simply installing the kit, the user is provided with instructions.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A kit for converting an all-terrain vehicle (ATV) to a snowmobile, the kit comprising:
two front axle adapters for operatively associating two skis with a front axle of the ATV, one ski on each opposing end, respectively, of said front axle; and
two rear axle adapters for operatively associating two track assemblies, one ski on each opposing end, respectively, of a rear axle of the ATV.

2. The kit of claim 1, wherein each front axle adapter comprises:
a head plate portion;
a body portion; and
a neck portion interconnecting the head plate portion and the body portion, wherein the neck portion tapers inward so as to define a bell shape relative the body portion.

3. The kit of claim 2, wherein a thickness of the head plate portion is one-third or less than a thickness of the body portion.

4. The kit of claim 3, wherein the head plate portion abuts a hub of the front axle.

5. The kit of claim 1, wherein each rear axle adapter comprises a half shaft have a spline portion for engaging one of the two track assemblies.

6. The kit of claim 5, further comprising a threaded insert lock nut that secures wherein the half shaft to said one of the two track assemblies.

7. The kit of claim 1, wherein each rear axle adapter comprises:
an axle mount having a four-corner arrangement of connectors;
an adapter portion comprising a first cross portion and a second cross portion, each cross portion having a four-corner arrangement of connection points offset from each other by approximately forty-five degrees; and
a core body interconnecting the axle mount and the adapter portion.

8. The kit of claim 7, further comprising a core hole extending a length of the adapter portion.

9. The kit of claim 8, further comprising a recessed second cross opening communicating with the core hole.

10. The kit of claim 9, wherein each front axle adapter comprises:
a head plate portion;
a body portion; and
a neck portion interconnecting the head plate portion and the body portion, wherein the neck portion tapers inward so as to define a bell shape relative the body portion.

11. The kit of claim 10, wherein a thickness of the head plate portion is one-third or less than a thickness of the body portion.

12. The kit of claim 11, wherein the head plate portion abuts a hub of the front axle.

13. The kit of claim 6, wherein each front axle adapter comprises:
a head plate portion;
a body portion; and
a neck portion interconnecting the head plate portion and the body portion, wherein the neck portion tapers inward so as to define a bell shape relative the body portion.

14. The kit of claim 13, wherein a thickness of the head plate portion is one-third or less than a thickness of the body portion.

15. The kit of claim 14, wherein the head plate portion abuts a hub of the front axle.
